(19) United States
(12) Patent Application Publication
(10) Pub. No.: US 2024/0102883 A1
(43) Pub. Date: Mar. 28, 2024

(54) VIBRATION REPRODUCTION DEVICE

(71) Applicant: NIPPON TELEGRAPH AND TELEPHONE CORPORATION, Tokyo (JP)

(72) Inventors: Yuta IKEGUCHI, Tokyo (JP); Daiki KOBAYASHI, Tokyo (JP); Daisuke UCHIBORI, Tokyo (JP); Atsushi ARATAKE, Tokyo (JP); Masafumi NAKAGAWA, Tokyo (JP)

(73) Assignee: NIPPON TELEGRAPH AND TELEPHONE CORPORATION, Tokyo (JP)

(21) Appl. No.: 17/767,418

(22) PCT Filed: Oct. 8, 2019
(86) PCT No.: PCT/JP2019/039721

§ 371 Date: Apr. 7, 2022

(51) Int. Cl. G01M 7/02

(52) U.S. Cl. CPC G01M 7/025; G01M 7/027

(57) ABSTRACT

A vibration reproduction device (100) is a vibration reproduction device that reproduces vibration of a pipeline (10) attached to a structure, and includes: a plurality of support members (101a, 101b) for supporting the pipeline; a fixing members (102a, 102b) for fastening the pipeline to the support members; support bases (103a, 103b) that are joined to the support members and to which a vibration force is applied; and viscoelastic members (106a, 106b) provided between the support bases and the ground.

### TECHNICAL FIELD

The present disclosure relates to a vibration reproduction device for reproducing vibration of a pipeline attached to a structure.

### BACKGROUND ART

In a pipeline-attached facility (see FIG. 7) in which pipelines are attached to a structure such as a bridge for the purpose of cabling, drainage, or the like, it is required to measure vibration characteristics (e.g., natural frequency etc.) of the pipelines and reflect the measurement results in the design in order to prevent resonance with the structure caused by traveling of a vehicle or the like. Since the actual pipeline-attached facilities take various forms depending on the shape of the pipelines, restraint conditions of U-shaped bolts, and so on, it is difficult to calculate the natural frequency of the pipelines on paper. For this reason, it is necessary to measure vibration of an actual facility or a pipeline that imitates the actual facility.

However, the actual facility is easily affected by the surrounding environment, and therefore measurement of vibration of a pipeline cannot be readily carried out. For this reason, a test method using a vibration reproduction device has been proposed (e.g., see NPL 1).

### CITATION LIST

### Non Patent Literature

[NPL 1] Daiki Kobayashi, Koji Tanaka, “Study on Resonance of Repairing FRP Pipe to be Attached to Bridges”, Annual Lecture of Japan Society of Civil Engineers, 2014

### SUMMARY OF THE INVENTION

### Technical Problem

However, conventional vibration reproduction devices are costly because those devices require a large hydraulic machine or the like, and furthermore, due to specifications, it is difficult to appropriately change the measurement conditions (e.g., span length, span number etc.) in accordance with the form of the pipeline-attached facility.

In view of the foregoing circumstances, an object of the present disclosure is to provide a vibration reproduction device that is inexpensive and can easily reproduce vibration of a pipeline.

### Means for Solving the Problem

A vibration reproduction device according to an embodiment is a vibration reproduction device that reproduces vibration of a pipeline attached to a structure, and includes: a plurality of support members for supporting the pipeline; fixing members for fastening the pipeline to the support members; support bases that are joined to the support members and to which a vibration force is applied; and viscoelastic members provided between the support bases and ground.

A vibration reproduction device according to an embodiment is a vibration reproduction device that reproduces vibration of a pipeline attached to a structure, and includes: a plurality of support members for supporting the pipeline; fixing members for fastening the pipeline to the support members; support bases that are joined to the support members and to which a vibration force is applied; a connecting member for maintaining upper surfaces of the support bases adjacent to each other, in the same plane; and viscoelastic members provided between the support bases and ground.

### Effects of the Invention

According to the present disclosure, it is possible to provide a vibration reproduction device that is inexpensive and can easily reproduce vibration of a pipeline.

### BRIEF DESCRIPTION OF DRAWINGS

FIG. 1A is a side view showing an example of a configuration of a vibration reproduction device according to a first embodiment.

FIG. 1B is a cross-sectional view showing an example of a configuration of the vibration reproduction device according to the first embodiment.

FIG. 1C is a side view showing an example of a configuration of a vibration reproduction device according to the first embodiment.

FIG. 2 is a diagram showing an example of a configuration of a support base and a viscoelastic member according to the first embodiment.

FIG. 3 is a diagram showing an example of a configuration of the viscoelastic member according to the first embodiment.

FIG. 4 is a side view showing an example of a configuration of a vibration reproduction device according to a second embodiment.

FIG. 5 is a side view showing an example of a configuration of a vibration reproduction device according to a third embodiment.

FIG. 6 is a side view showing an example of a configuration of a vibration reproduction device according to a fourth embodiment.

FIG. 7A is a diagram showing an example of a configuration of a pipeline-attached facility.

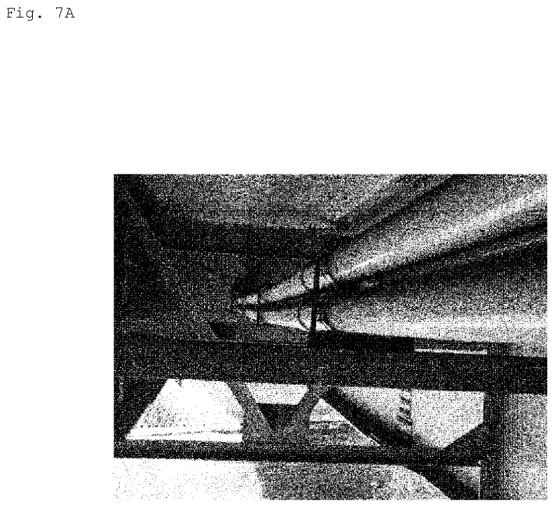

FIG. 7B is a diagram showing an example of a configuration of the pipeline-attached facility.

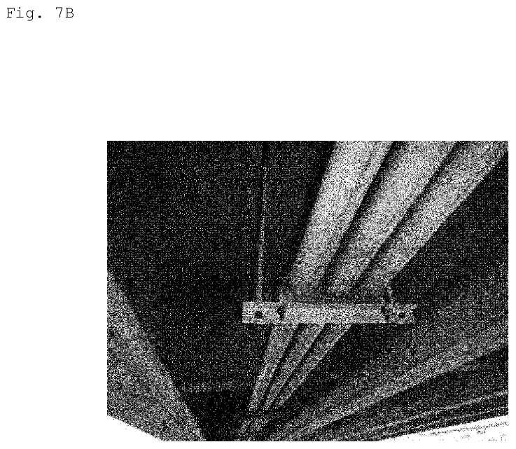

### DESCRIPTION OF EMBODIMENTS

Modes for carrying out the present invention will be described below with reference to the drawings.

### <Configuration of Vibration Reproduction Device>

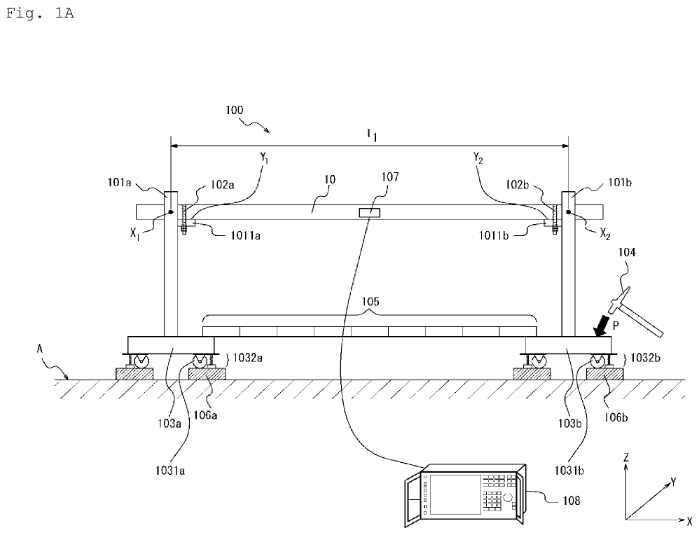

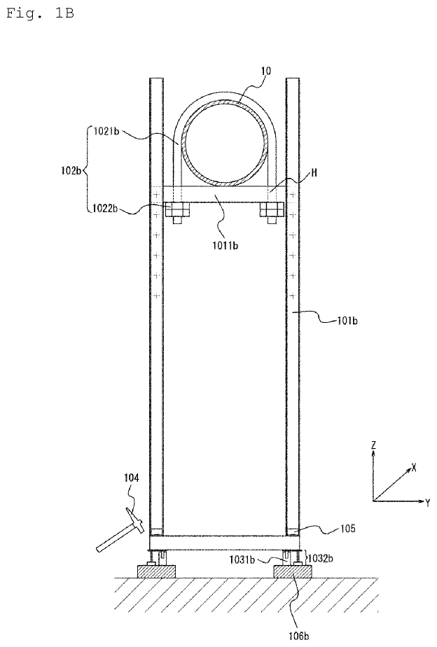

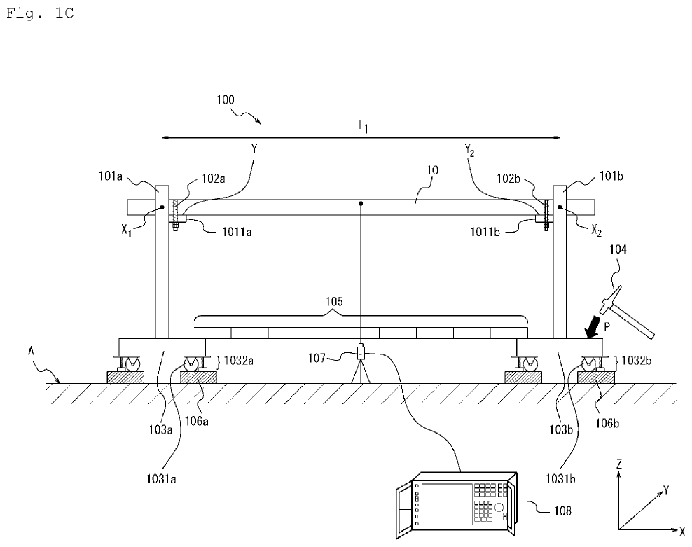

A vibration reproduction device 100 according to an embodiment of the present invention will be described with reference to FIGS. 1 to 3. Note that the description will be given as appropriate, while assuming that, in FIG. 1, the left-right direction of the vibration reproduction device 100 corresponds to an X axis, the front-back direction of the vibration reproduction device 100 (a direction perpendicular to the paper) corresponds to a Y axis, and the up-down direction of the vibration reproduction device 100 corresponds to a Z direction.

The vibration reproduction device 100 is a device for use in a laboratory to reproduce vibration of a pipeline attached to a structure. A pipeline 10 is, for example, a rigid vinyl pipe, an FRP (Fiber Reinforced Plastics) pipe, a steel pipe, an FRPM (Fiberglass Reinforced Plastic Mortar) pipe, or the like. Although FIG. 1 shows an example of the case in which one pipeline 10 is installed in the vibration reproduction device 100, the form of the pipeline 10 installed in the vibration reproduction device 100 is not specifically limited. For example, pipelines may be installed in a form that imitates the form in which the pipelines are laid in an actual pipeline-attached facility, e.g., in a two-row/two-stage or three-row/one-stage form, in the vibration reproduction device 100. The pipeline 10 need only have a cylindrical shape and the diameter or the material thereof is not specifically limited. The pipeline 10 may be provided with a joint or the like and may be uneven.

The vibration reproduction device 100 includes a plurality of support members 101a and 101b, a plurality of fixing members 102a and 102b, a plurality of support bases 103a and 103b, a vibration-applying portion 104, a connecting member 105, a plurality of viscoelastic members 106a and 106b, a detection unit 107, and a measurement unit 108.

The support member 101a has a support portion 1011a, and supports the pipeline 10 at a support point X₁ of the support portion 1011a. The support portion 1011a is provided with open holes H for the fixing member 102a to be inserted thereinto. The support member 101b has a support portion 1011b, and supports the pipeline 10 at a support point X₂ of the support portion 1011b. The support portion 1011b is provided with open holes H for the fixing member 102b to be inserted thereinto.

The support members 101a and 101b need only have a configuration that enables the pipeline 10 to be stably supported and in which the surfaces of the support portions 1011a and 1011b on which the pipeline 10 is installed are flat surfaces. The support members 101a and 101b are formed with, for example, groove steel members, L-shaped steel members, flat steel members, H-shaped steel members, or the like. The support members 101a and 101b are formed to have a length in the X-axis direction of about 6.5 cm and a length in the Z-axis direction of about 1.5 m, for example. The support portions 1011a and 1011b are formed to have a length in the Y-axis direction of about 75 cm and a length in the Z-axis direction of about 6.5 cm, for example.

The direction between the support point X₁ and the support point X₂ is called a span length. An operator can change, as appropriate, the span length by adjusting the positions at which the support bases 103a and 103b are arranged. If, for example, the pipeline 10 is a rigid vinyl pipe, the operator can set the span length as 1=2.5 m. If, for example, the pipeline 10 is an FRP pipe, the operator can set the span length as 1=5.0 m.

The number of sections between support points on the pipeline 10 that is supported by a plurality of support members is called a span number. An operator can change, as appropriate, the span number by adjusting the positions at which the support bases 103a and 103b are arranged. If, for example, the pipeline 10 is a rigid vinyl pipe, the operator can set the span length as 1=2.5 m and set the span number to 1, or can set the span length as 1=5.0 m and set the span number to 2.

The fixing members 102a and 102b fasten the pipeline 10 to the support members 101a and 101b. The fixing member 102a includes a U-shaped bolt 1021a and nuts 1022a, for example. The fixing member 102b includes a U-shaped bolt 1021b and nuts 1022b, for example.

Each of the U-shaped bolts 1021a and 1021b is a single steel material that is curved at a center portion thereof and has a bolt structure at the two end portions. The U-shaped bolts 1021a and 1021b are attached to the support portions 1011a and 1011b so as to hold the pipeline 10, and the two end portions of the U-shaped bolts 1021a and 1021b are inserted into the open holes H provided in the support portions 1011a and 1011b, respectively.

Each of the nuts 1022a and 1022b has a structure in which the outer diameter thereof is larger than the outer diameter of each open hole. The nuts 1022a and 1022b sandwich the pipeline 10 and the support portions 1011a and 1011b from the surfaces of the support portions 1011a and 1011b on the side opposite to support surfaces Y₁ and Y₂, and are screwed to the two end portions of the U-shaped bolts 1021a and 1021b, respectively. Thus, the pipeline 10 is fastened to the support members 101a and 101b by the fixing members 102a and 102b.

The support bases 103a and 103b are joined to the support members 101a and 101b, respectively, which stand on the respective support bases 103a and 103b. Vibration force is applied to a vibration application point P on the support base 103a or 103b by the vibration-applying portion 104. For example, when the operator hits the vibration application point P using the vibration-applying portions 104, impact vibration force is applied to the vibration application point P. Although, in FIG. 1, the vibration application point P is set at a predetermined position on the support base 103b, the vibration application point P may alternatively be set at a predetermined position on the support base 103a. Regardless of whether the vibration application point P is set on the support base 103a or the support base 103b, it is preferable to set the vibration application point P at a position at which the accuracy of vibration measurement is enhanced.

The support bases 103a and 103b vibrate based on the applied vibration force. The vibration of the support bases 103a and 103b is transmitted to the pipeline 10 via the support members 101a and 101b. By vibrating the support bases 103a and 103b to indirectly apply vibration to the pipeline 10, a forced vibration component deriving from the applied vibration is difficult to be transmitted to the pipeline 10, and thus, a free vibration component that may cause resonance can be measured highly accurately by the measurement unit 108. Further, even if the vibration of the support bases 103a and 103b is small, the thinner the support members 101a and 101b are, the vibration is more easily transmitted to the pipeline 10. Accordingly, vibration that imitates vibration with large energy, such as traffic vibration, can be easily generated on the pipeline 10 by thinning the support members 101a and 101b to some extent.

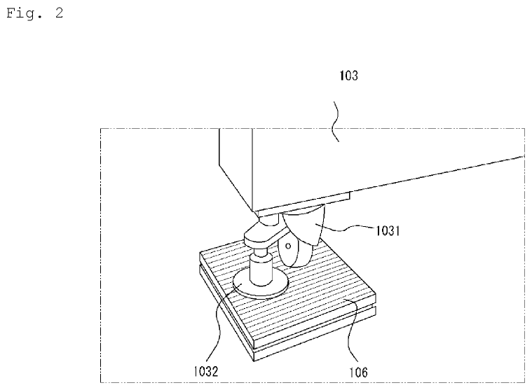

As shown in FIG. 2, the support members 103a and 103b have casters 1031a and 1031b and adjuster feet 1032a and 1032b, respectively, at four corners of the surface on the side opposite to the surface joined to the support members 101a and 101b.

The support bases 103a and 103b are fixed to the ground A via the viscoelastic members 106a and 106b by the adjuster feet 1032a and 1032b, respectively. Since the support bases 103a and 103b have the adjuster feet 1032a and 1032b, the support points X₁ and X₂ of the support members 101a and 101b that support the pipeline 10 can be prevented from changing even if the vibration force is applied to the support bases 103a and 103b and the support bases 103a and 103b vibrate.

Meanwhile, when the adjuster feet 1032a and 1032b are released, the support bases 103a and 103b can move on the ground A using the casters 1031a and 1031b. Since the support bases 103a and 103b have the casters 1031a and 1031b, the operator can move the support bases 103a and 103b to any position. The operator can easily carry out vibration measurement with various span lengths and span numbers by arranging the support bases 103a and 103b in accordance with a desired span length and span number.

The vibration-applying portion 104 applies vibration force to the support bases 103a and 103b. The vibration-applying portion 104 may apply vibration force to a predetermined position on the support base 103a, or may apply vibration force to a predetermined position on the support base 103b.

The vibration-applying portion 104 is, for example, a rubber hammer. For example, when the operator hits the vibration application point P using a rubber hammer, impact vibration force is applied to the vibration application point P. Although the form of the vibration-applying portion 104 is not specifically limited, damage to the vibration reproduction device 100 can be prevented and the operator can easily apply vibration force to the support base 103a or the support base 103b by using a rubber hammer as the vibration-applying portion 104.

As a result of the vibration-applying portion 104 applying vibration force to the vibration application point P, the support base 103a or 103b vibrates, and the vibration of the support base 103a or 103b is transmitted to the pipeline 10 via the support member 101a or 101b. Thus, the operator can realistically reproduce vibration that imitates vibration generated on a pipeline that resonates with a bridge on which vehicles travel, for example, while being in a laboratory.

Note that the vibration-applying portion 104 may also include a sensor unit capable of wirelessly communicating with the measurement unit 108, for example. In this case, the sensor unit detects the vibration force applied to the support base 103a or 103b and outputs various data at the time of impact vibration to the measurement unit 108, and thus the measurement unit 108 can more accurately measure vibration characteristics of the pipeline 10 while giving consideration to these data.

The connecting member 105 connects an upper surface of the support base 103a and an upper surface of the support base 103b to so as to maintain these upper surfaces on the same plane. The connecting member 105 includes, for example, a shape steel, reinforcing ribs, or the like. By providing the connecting member 105, the straight line between the upper surface of the support base 103a and the upper surface of the support base 103b is ensured.

The viscoelastic members 106a and 106b are provided between the support bases 103a and 103b and the ground A, respectively. The viscoelastic member 106a has a rectangular flat plate shape, and is provided at each of four corners of a surface of the support base 103a on the side opposite to the surface joined to the support member 101a. The viscoelastic member 106b has a rectangular flat plate shape, and is provided at each of four corners of a surface of the support base 103b on the side opposite to the surface joined to the support member 101b.

The viscoelastic members 106a and 106b are in a state of being appropriately pressed by the adjuster feet 1032a and 1032b, respectively. When the support bases 103a and 103b vibrate, the viscoelastic members 106a and 106b are elastically deformed between the support bases 103a and 103b and the ground A, respectively.

The viscoelastic members 106a and 106b may be made of any viscoelastic material, and is made of a material such as rubber, resin, or urethane, for example. However, from the viewpoint of vibration measurement, it is desirable that the viscoelastic members 106a and 106b are members made of rubber, such as rubber mats. This is because rubber has a lower loss coefficient than that of other materials and can effectively prevent vibration.

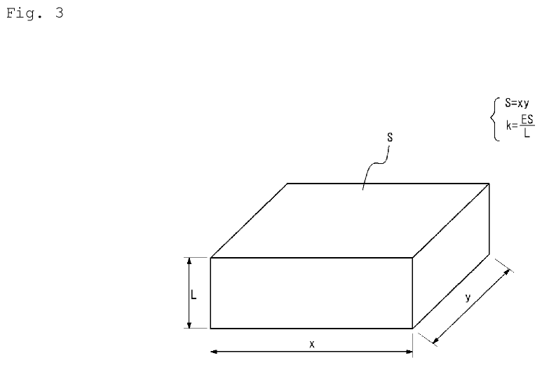

FIG. 3 is a diagram showing an example of the viscoelastic members 106a and 106b. When the spring constant of the viscoelastic members 106a and 106b is k, the sum of the mass of the pipeline 10, the mass of the support bases 103a and 103b, and the mass of the connecting member 105 is m, the angular frequency of the mass system (the pipeline 10, the support bases 103a and 103b, the connecting member 105) is co, the cross-sectional area of the viscoelastic members 106a and 106b is S=xy, the height of the viscoelastic members 106a and 106b is L, and the Young's modulus of the viscoelastic members 106a and 106b is E, the viscoelastic members 106a and 106b are configured so as to satisfy the following expression (1):

[Math. 1]

ω>\sqrt{2}ωₙ(where,ωₙ=\sqrt{k/m}=\sqrt{(ES)/(mL)}=\sqrt{(Exy)/(mL)}) (1)

As a result of the viscoelastic members 106a and 106b being configured so as to satisfy the expression (1), a mass system similar to that of an actual pipeline-attached facility can be reproduced in a laboratory. Further, since vibration transmitted from the support bases 103a and 103b to the ground A can be attenuated by providing the viscoelastic members 106a and 106b between the support bases 103a and 103b and the ground A, it is possible to eliminate reaction force applied from the ground A to the vibration reproduction device 100 due to the vibration force being applied to the support base 103a or 103b. As a result, the vibration reproduction device 100 can be realized that can easily reproduce vibration of the pipeline 10 without need for a large machine or the like.

Note that if the connecting member 105 is not provided between the support bases 103a and 103b, when the spring constant of the viscoelastic members 106a and 106b is k, the sum of the mass of the pipeline 10 and the mass of the support bases 103a and 103b is m, the angular frequency of the mass system (the pipeline 10 and the support bases 103a and 103b) is co, the cross-sectional area of the viscoelastic members 106a and 106b is S=xy, the height of the viscoelastic members 106a and 106b is L, and the Young's modulus of the viscoelastic members 106a and 106b is E, the viscoelastic members 106a and 106b are configured so as to satisfy the above expression (1).

The detection unit 107 detects vibration of the pipeline 10 and outputs the detection result to the measurement unit 108. The detection unit 107 is, for example, a contact type acceleration sensor, a non-contact type laser Doppler vibrometer, or the like. If the detection unit 107 is an acceleration sensor, the acceleration sensor is provided at a center portion of the pipeline 10 as shown in FIG. 1A, and detects vibration of the pipeline 10. If the detection unit 107 is a laser Doppler vibrometer, the laser Doppler vibrometer is provided a predetermined distance (e.g., 2 m) away from the vibration reproduction device 100 as shown in FIG. 1C, emits a laser beam to the center portion of the pipeline 10, converts a frequency change in a Doppler-shifted reflected laser to a voltage, and thus detects vibration of the pipeline 10.

The measurement unit 108 measures vibration characteristics of the pipeline 10 based on the detection result input from the detection unit 107. The measurement unit 108 is, for example, an FFT (Fast Fourier Transform) analyzer and measures the natural frequency of the pipeline 10. Note that the measurement unit 108 may be configured to not only be connected to the detection unit 107 in a wired manner as shown in FIG. 1, but also wirelessly communicate with the measurement unit 108.

The operator can ascertain whether or not the pipeline 10 is safe against resonance with a bridge due to traffic vibration in a pipeline-attached facility, for example, based on the result of measurement performed by the measurement unit 108. That is to say, the operator can reflect information (vibration characteristics of the pipeline 10) acquired based on the vibration of the pipeline 10 reproduced by the vibration reproduction device 100 in the design of the pipeline-attached facility. Thus, it is possible to achieve the increased efficiency and sophistication of maintenance and management of the pipeline-attached facility.

In the vibration reproduction device 100 according to the present embodiment, the viscoelastic members 106a and 106b that satisfy ω>(2 k/m)^{1/2} are provided between the ground A and the support bases 103a and 103b, respectively. As a result, the vibration reproduction device 100 can be realized that is inexpensive and can easily reproduce vibration of a pipeline.

The vibration reproduction device 100 according to the present embodiment can also change, as appropriate, measurement conditions such as the span length and the span number, as per the form of the pipeline-attached facility. Thus, the operator can perform desired verification without worrying about limitations on the specifications of the device.

### Second Embodiment

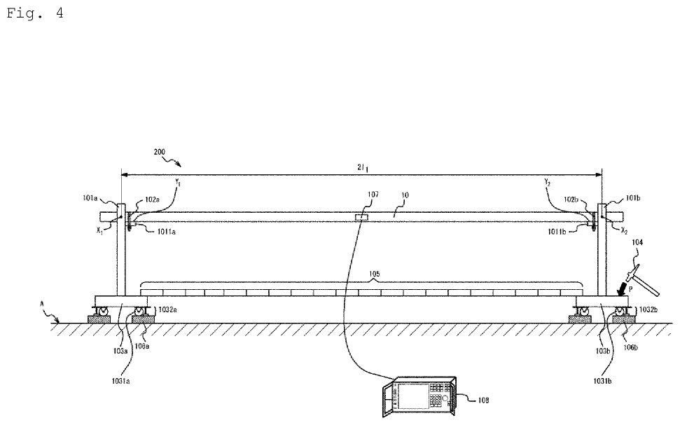

Next, a vibration reproduction device 200 according to the second embodiment will be described with reference to FIG. 4.

The vibration reproduction device 200 according to the second embodiment differs from the vibration reproduction device 100 according to the first embodiment in that the span length in the vibration reproduction device 200 according to the second embodiment is 21, while the span length in the vibration reproduction device 100 according to the first embodiment is 1. Since the other configurations are the same as those of the vibration reproduction device 200 according to the first embodiment, redundant description is omitted.

The operator releases the adjuster feet 1032a and 1032b, moves the support bases 103a and 103b to arrange the support bases 103a and 103b at appropriate positions, and adjusts the positions at which the support bases 103a and 103b are arranged such that the span length is 21. Thus, the operator can change, as appropriate, the span length from 1 to 21, or from 21 to 1, only by moving the support bases 103a and 103b.

In the vibration reproduction device 200 according to the present embodiment, the viscoelastic members 106a and 106b that satisfy ω>(2 k/m)^{1/2} are provided between the ground A and the support bases 103a and 103b, respectively. As a result, the vibration reproduction device 200 can be realized that is inexpensive and can easily reproduce vibration of a pipeline.

Further, the vibration reproduction device 200 according to the present embodiment can perform measurement in accordance with various span lengths. Accordingly, the operator can perform desired verification economically and easily.

### Third Embodiment

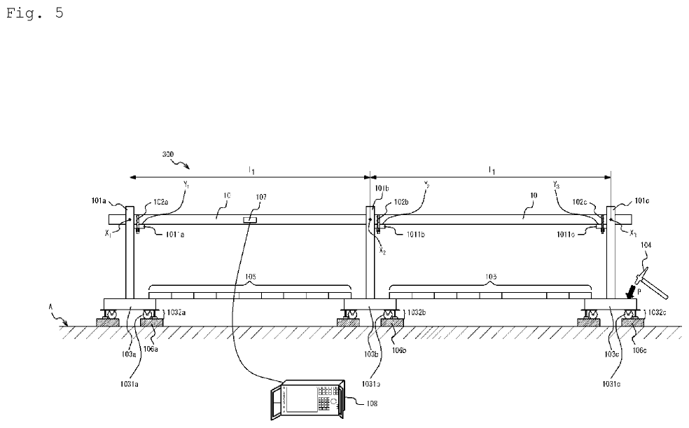

Next, a vibration reproduction device 300 according to the third embodiment will be described with reference to FIG. 5.

The vibration reproduction device 300 according to the third embodiment differs from the vibration reproduction device 100 according to the first embodiment in that the span number in the vibration reproduction device 300 according to the third embodiment is 2, while the span number in the vibration reproduction device 100 according to the first embodiment is 1. Since the other configurations are the same as those of the vibration reproduction device 100 according to the first embodiment, redundant description is omitted.

The vibration reproduction device 300 includes a plurality of support members 101a, 101b, and 101c, a plurality of fixing members 102a, 102b, and 102c, a plurality of support bases 103a, 103b, and 103c, a vibration-applying portion 104, a connecting member 105, a plurality of viscoelastic members 106a, 106b, and 106c, a detection unit 107, and a measurement unit 108.

The support member 101a has a support portion 1011a, and supports the pipeline 10 at a support point X₁ of the support portion 1011a. The support portion 1011a is provided with open holes H for the fixing member 102a to be inserted thereinto. The support member 101b has a support portion 1011b, and supports the pipeline 10 at a support point X₂ of the support portion 1011b. The support portion 1011b is provided with open holes H for the fixing member 102b to be inserted thereinto. The support member 101c has a support portion 1011c, and supports the pipeline 10 at a support point X₃ of the support portion 1011c. The support portion 1011c is provided with open holes H for the fixing member 102c to be inserted thereinto.

The distance between the support point X₁ and the support point X₂ is 1, the distance between the support point X₂ and the support point X₃ is 1, and the distance between the support point X₁ and the support point X₃ is 21.

The operator releases the adjuster feet 1032a, 1032b, and 1032c, moves the support bases 103a, 103b, and 103c to arrange the support bases 103a, 103b, and 103c at appropriate positions, and adjusts the positions at which the support bases 103a, 103b, and 103c are arranged such that the span number is 2. Thus, the operator can change, as appropriate, the span number from 1 to 2 only by moving the support bases 103a, 103b, and 103c.

The fixing members 102a, 102b, and 102c fasten the pipeline 10 to the support members 101a, 101b, and 101c. The fixing member 102a includes a U-shaped bolt 1021a and a nut 1022a, for example. The fixing member 102b includes a U-shaped bolt 1021b and a nut 1022b, for example. The fixing member 102c includes a U-shaped bolt 1021c and a nut 1022c, for example.

The support bases 103a, 103b, and 103c are joined to the support members 101a, 101b, and 101c, respectively, which stand on the respective support bases 103a, 103b, 103c. Vibration force is applied to a vibration application point P on the support base 103a, 103b, or 103c by the vibration-applying portion 104.

The viscoelastic members 106a, 106b, and 106c are provided between the support bases 103a, 103b, and 103c and the ground A, respectively. The viscoelastic member 106a has a rectangular flat plate shape, and is provided at each of four corners of a surface of the support base 103a on the side opposite to the surface joined to the support member 101a. The viscoelastic member 106b has a rectangular flat plate shape, and is provided at each of four corners of a surface of the support base 103b on the side opposite to the surface joined to the support member 101b. The viscoelastic member 106c has a rectangular flat plate shape, and is provided at each of four corners of a surface of the support base 103c on the side opposite to the surface joined to the support member 101c.

The viscoelastic members 106a, 106b, and 106c are in a state of being appropriately pressed by the adjuster feet 1032a, 1032b, and 1032c, respectively. When the support bases 103a, 103b, and 103c vibrate, the viscoelastic members 106a, 106b, and 106c are elastically deformed between the support bases 103a, 103b, and 103c and the ground A, respectively.

The detection unit 107 detects vibration of the pipeline 10 and outputs the detection result to the measurement unit 108. The detection unit 107 is, for example, a contact type acceleration sensor, a non-contact type laser Doppler vibrometer, or the like. Since the pipeline 10 installed over the left and right spans in the vibration reproduction device 300 is the same pipeline and is horizontally symmetrical as shown in FIG. 5, the detection unit 107 need only be installed only at the center portion of either span.

In the vibration reproduction device 300 according to the present embodiment, the viscoelastic members 106a, 106b, and 106c that satisfy ω>(2 k/m)^{1/2} are provided between the ground A and the support bases 103a, 103b, and 103c, respectively. As a result, the vibration reproduction device 300 can be realized that is inexpensive and can easily reproduce vibration of a pipeline.

Further, the vibration reproduction device 300 according to the present embodiment can perform measurement in accordance with various span lengths. Accordingly, the operator can perform desired verification economically and easily.

### Fourth Embodiment

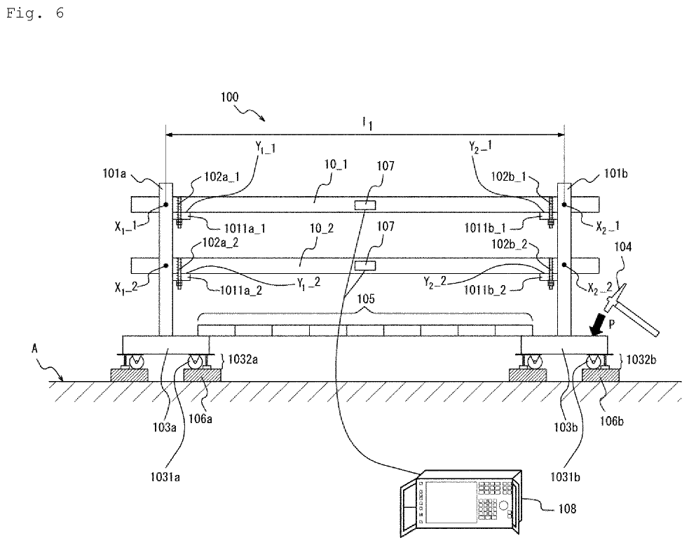

Next, a vibration reproduction device 400 according to the fourth embodiment will be described with reference to FIG. 6.

The vibration reproduction device 400 according to the fourth embodiment differs from the vibration reproduction device 100 according to the first embodiment in that the support members 101a and 101b of the vibration reproduction device 400 according to the fourth embodiment are in a mode of supporting pipelines 10 in two stages, while the support members 101a and 101b of the vibration reproduction device 100 according to the first embodiment is in a mode of supporting the pipeline 10 in a single stage. Since the other configurations are the same as those of the vibration reproduction device 100 according to the first embodiment, redundant description is omitted.

The vibration reproduction device 400 includes a plurality of support members 101a and 101b, a plurality of fixing members 102a and 102b, a plurality of support bases 103a and 103b, a vibration-applying portion 104, a connecting member 105, a plurality of viscoelastic members 106a and 106b, a detection unit 107, and a measurement unit 108.

The support member 101a has a support portion 1011a_1 and a support portion 1011a_2, supports a pipeline 10_1 at a support point X₁_1 of the support portion 1011a_1, and supports a pipeline 10_2 at a support point X₁_2 of the support portion 1011a_2. The support portion 1011a_1 is provided with open holes H for the fixing member 102a_1 to be inserted thereinto. The support portion 1011a_2 is provided with open holes H for the fixing member 102a_2 to be inserted thereinto.

The support member 101b has a support portion 1011b_1 and a support portion 1011b_2, supports a pipeline 10_1 at a support point X₂_1 of the support portion 1011b_1, and supports a pipeline 10_2 at a support point X₂_2 of the support portion 1011b_2. The support portion 1011b_1 is provided with open holes H for the fixing member 102b_1 to be inserted thereinto. The support portion 1011b_2 is provided with open holes H for the fixing member 102b_2 to be inserted thereinto.

The support members 101a and 101b support the pipeline 10_1 in the upper stage (the support portions 1011a_1 and 1011b_1) and supports the pipeline 10_2 in the lower stage (the support portions 1011a_2 and 1011b_2). That is to say, the vibration reproduction device 400 can simultaneously reproduce and measure vibration of the pipelines 10_1 and 10_2 installed in two stages due to the support members 101a and 101b supporting the pipelines 10_1 and 10_2 in the upper and lower two stages.

The fixing members 102a_1 and 102b_1 fasten the pipeline 10_1 to the support members 101a and 101b. The fixing members 102a_2 and 102b_2 fasten the pipeline 10_2 to the support members 101a and 101b. The fixing members 102a_1 and 102a_2 include U-shaped bolts 1021a_1 and 1021a_2 and nuts 1022a_1 and 1022a_2, respectively. The fixing members 102b_1 and 102b_2 include U-shaped bolts 1021b_1 and 1021b_2 and nuts 1022b_1 and 1022b_2 respectively.

The U-shaped bolts 1021a_1 and 1021b_1 are attached to the support portions 1011a_1 and 1011b_1 so as to hold the pipeline 10_1, and the two end portions of each of the U-shaped bolts 1021a_1 and 1021b_1 are inserted into the open holes H provided in the support portions 1011a_1 and 1011b_1, respectively. The U-shaped bolts 1021a_2 and 1021b_2 are attached to the support portions 1011a_2 and 1011b_2 so as to hold the pipeline 10_2, and the two end portions of each of the U-shaped bolts 1021a_2 and 1021b_2 are inserted into the open holes H provided in the support portions 1011a_2 and 1011b_2, respectively.

The nuts 1022a_1 and 1022b_1 sandwich the pipeline 10_1 and the support portions 1011a_1 and 1011b_1 from the surfaces of the support portions 1011a_1 and 1011b_1 on the side opposite to support surfaces Y₁_1 and Y₂_1, and are screwed to the two end portions of the U-shaped bolts 1021a_1 and 1021b_1, respectively. Thus, the pipeline 10_1 is fastened to the support members 101a and 101b by the fixing members 102a_1 and 102b_1. The nuts 1022a_2 and 1022b_2 sandwich the pipeline 10_2 and the support portions 1011a_2 and 1011b_2 from the surfaces of the support portions 1011a_2 and 1011b_2 on the side opposite to support surfaces Y₁_2 and Y₂_2, and are screwed to the two end portions of the U-shaped bolts 1021a_2 and 1021b_2, respectively. Thus, the pipeline 10_2 is fastened to the support members 101a and 101b by the fixing members 102a_2 and 102b_2.

In the vibration reproduction device 400 according to the present embodiment, the viscoelastic members 106a and 106b that satisfy ω>(2 k/m)^{1/2} are provided between the ground A and the support bases 103a and 103b, respectively. As a result, the vibration reproduction device 400 can be realized that is inexpensive and can easily reproduce vibration of a pipeline.

Further, the vibration reproduction device 400 according to the present embodiment can simultaneously reproduce and measure vibration of the pipelines 10_1 and 10_2 that are installed in the upper and lower two stages. Thus, the operator can economically and efficiently perform desired verification in accordance with various forms of pipeline-attached facilities.

Although the above embodiments have been described as representative examples, it is apparent to those skilled in the art that many changes and substitutions can be made within the gist and scope of the disclosure. Accordingly, the present invention should not be construed as being limited by the above embodiments, and various variations and changes can be made without departing from the claims.

For example, although the embodiments have given the description while taking example configurations in which the vibration reproduction device includes four or six support members 101, the number of support members 101 is not limited thereto.

Although the embodiments have given the description while taking example configurations in which the vibration reproduction device includes two to four fixing members 102, the number of fixing members 102 is not limited thereto. The number of fixing members 102 need only be more than one, and may be five or more.

Although the embodiments have given the description while taking example configurations in which the vibration reproduction device includes two or three support bases 103, the number of support bases 103 is not limited thereto. The number of support bases 103 need only be more than one, and may be four or more.

Although the embodiments have given the description while taking example configurations in which the vibration reproduction device includes eight or twelve viscoelastic members 106, the number of viscoelastic members 106 is not limited thereto.

### REFERENCE SIGNS LIST

10 Pipeline
100, 200, 300, 400 Vibration reproduction device
101a, 101b, 101c Support member
102a, 102b, 102c Fixing member
103a, 103b, 103c Support base
104 Vibration-applying portion
105 Connecting member
106a, 106b, 106c Viscoelastic member
107 Detection unit
108 Measurement unit
1011a, 1011b Support portion
1031a, 1031b Caster
1032a, 1032b Adjuster foot

1. A vibration reproduction device for reproducing vibration of a conduit pipeline attached to a structure, the device comprising:
a plurality of support members for supporting the conduit pipeline;
fixing members for fastening the conduit pipeline to the plurality of support members;
support bases that are joined to the plurality of support members and to which a vibration force is applied; and
viscoelastic members provided between the support bases and ground.

2. The vibration reproduction device according to claim 1,
wherein, when a spring constant of the viscoelastic members is k, a sum of a weight of the conduit pipeline and a weight of a plurality of the support bases is m, and an angular frequency of a mass system is ω,
the viscoelastic members satisfy:
ω>\sqrt{2 k/m}.

3. A vibration reproduction device that reproduces vibration of a conduit pipeline attached to a structure, the device comprising:
a plurality of support members for supporting the conduit pipeline;
fixing members for fastening the conduit pipeline to the plurality of support members;
support bases that are joined to the plurality of support members and to which a vibration force is applied;
a connecting member for maintaining upper surfaces of the support bases adjacent to each other, in the same plane; and
viscoelastic members provided between the support bases and ground.

4. The vibration reproduction device according to claim 3,
wherein, when a spring constant of the viscoelastic members is k, a sum of a weight of the conduit pipeline, a mass of a plurality of the support bases, and a weight of the connecting member is m, and an angular frequency of a mass system is co,
the viscoelastic members satisfy:
ω>\sqrt{2 k/}.

5. The vibration reproduction device according to claim 1,
wherein the viscoelastic members are made of rubber.

6. The vibration reproduction device according to claim 1, further comprising:
a vibration-applying nmember configured to apply the vibration force to a support base among the support bases;
a detection member configured to detect the vibration of the conduit pipeline; and
a measurement member configured to measure a vibration characteristic of the conduit pipeline.

7. The vibration reproduction device according to claim 2, wherein the viscoelastic members are made of rubber.

8. The vibration reproduction device according to claim 2, further comprising:
a vibration-applying member configured to apply the vibration force to a support base among the support bases;
a detection member configured to detect the vibration of the conduit pipeline; and
a measurement member configured to measure a vibration characteristic of the conduit pipeline.

9. The vibration reproduction device according to claim 3, wherein the viscoelastic members are made of rubber.

10. The vibration reproduction device according to claim 3, further comprising:
a vibration-applying member configured to apply the vibration force to a support base among the support bases;
a detection member configured to detect the vibration of the conduit pipeline; and
a measurement member configured to measure a vibration characteristic of the conduit pipeline.

11. The vibration reproduction device according to claim 4, wherein the viscoelastic members are made of rubber.

12. The vibration reproduction device according to claim 4, further comprising:
a vibration-applying member configured to apply the vibration force to a support base among the support bases;
a detection member configured to detect the vibration of the conduit pipeline; and
a measurement member configured to measure a vibration characteristic of the conduit pipeline.

13. The vibration reproduction device according to claim 5, further comprising:
a vibration-applying member configured to apply the vibration force to a support base among the support bases;
a detection member configured to detect the vibration of the conduit pipeline; and
a measurement member configured to measure a vibration characteristic of the conduit pipeline.

14. The vibration reproduction device according to claim 6, wherein the detection member includes an acceleration sensor at a center portion of the conduit pipeline.

15. The vibration reproduction device according to claim 6, wherein the detection member includes a laser Doppler vibrometer placed at least a predetermined distance away from the conduit pipeline.

16. The vibration reproduction device according to claim 6, wherein the measurement member includes a Fast Fourier Transform analyzer configured to analyze a natural frequency of the conduit pipeline.

17. The vibration reproduction device according to claim 6, wherein the conduit pipeline forms a cylindrical shape.

18. The vibration reproduction device according to claim 6, wherein the plurality of support members are formed with one of: groove steel members, L-shaped steel members, flat steel members, or H-shaped steel members.

19. The vibration reproduction device according to claim 6, wherein the vibration-applying member includes a rubber hammer preventing causing a damage to the support bases.

20. The vibration reproduction device according to claim 6, wherein a number of sections formed between the support bases is adjustable.
